(19) United States
(12) Patent Application Publication
(10) Pub. No.: US 2005/0042454 A1
(43) Pub. Date: Feb. 24, 2005

(54) Fuel cell gas diffusion layer

(75) Inventors: Shawn Zhao, Westboro, MA (US); Richard Gahan, Wrentham, MA (US)

Correspondence Address: FISH & RICHARDSON PC, 225 FRANKLIN ST, BOSTON, MA, 02110, US

(73) Assignee: Hollingsworth & Vose Company, East Walpole, MA (US)

(21) Appl. No.: 10/930,066

(22) Filed: Aug. 31, 2004

Related U.S. Application Data
(60) Provisional application No. 60/499,695, filed on Sep. 3, 2003.

(51) Int. Cl. B32B 9/00; H01F 1/00

(52) U.S. Cl. 428/408; 428/332; 429/12

(57) ABSTRACT

Fuel cell gas diffusion layers are disclosed.

### CROSS-REFERENCE TO RELATED APPLICATION

This application claims priority under 35 U.S.C. §119(e) to U.S. Provisional Patent Application Ser. No. 60/499,695, filed Sep. 3, 2003, and entitled “Fuel Cell Gas Diffusion Layer”, which is hereby incorporated by reference.

### TECHNICAL FIELD

The invention relates to fuel cell gas diffusion layers containing melt blown filaments.

### BACKGROUND

Fuel cells can be used to convert chemical energy to electrical energy by promoting a chemical reaction between, for example, hydrogen and oxygen.

FIG. 1 shows an embodiment of a fuel cell 100. Fuel cell 100 includes a solid electrolyte 110, a cathode catalyst 120, an anode catalyst 130, a cathode gas diffusion layer 140, an anode gas diffusion layer 150, a cathode flow field plate 160 having channels 162, and an anode flow field plate 170 having channels 172.

Solid electrolyte 110 can be formed of a solid polymer, such as a solid polymer ion exchange resin (e.g., a solid polymer proton exchange membrane). Examples of proton exchange membrane materials include partially sulfonated, fluorinated polyethylenes, which are commercially available as the NAFION® family of membranes (E.I. DuPont deNemours Company, Wilmington, Del.).

Cathode and anode catalysts 120 and 130 can be formed, for example, of platinum, a platinum alloy, or platinum dispersed on carbon black.

Cathode and anode flow field plates 160 and 170 can be formed of a solid, electrically conductive material, such as graphite.

Typically, fuel cell 100 operates as follows.

Hydrogen enters anode flow field plate 170 at an inlet region of anode flow field plate 170 and flows through channels 172 toward an outlet region of anode flow field plate 170. At the same time, oxygen (e.g., air containing oxygen) enters cathode flow field plate 160 at an inlet region of cathode flow field plate 160 and flows through channels 162 toward an outlet region of cathode flow field plate 160.

As the hydrogen flows through channels 172, the hydrogen passes through anode gas diffusion layer 150 and interacts with anode catalyst 130, and, as oxygen flows through channels 162, the oxygen passes through cathode gas diffusion layer 140 and interacts with cathode catalyst 120. Anode catalyst 130 interacts with the hydrogen to catalyze the conversion of the hydrogen into electrons and protons, and cathode catalyst 120 interacts with the oxygen, electrons and protons to form water. The water flows through gas diffusion layer 150 to channels 162, and then along channels 162 toward the outlet region of cathode flow field plate 160.

Solid electrolyte 110 provides a barrier to the flow of the electrons and gases from one side of electrolyte 110 to the other side of the electrolyte 110. But, electrolyte 110 allows the protons to flow from the anode side of membrane 110 to the cathode side of membrane 110. As a result, the protons can flow from the anode side of membrane 110 to the cathode side of membrane 110 without exiting fuel cell 100, whereas the electrons flow from the anode side of membrane 110 to the cathode side of membrane 110 via an electrical circuit that is external to fuel cell 100. The external electrical circuit is typically in electrical communication with anode flow field plate 170 and cathode flow field plate 160.

In general, the electrons flowing through the external electrical circuit are used as an energy source for a load within the external electrical circuit.

### SUMMARY

The invention relates to fuel cell gas diffusion layers containing melt blown filaments (e.g., melt blow filaments in the form of a sheet).

In one aspect, the invention features a method of making a fuel cell gas diffusion layer. The method includes extruding a carbonaceous material through openings in a die to form carbonaceous filaments, contacting the carbonaceous filaments with a gas stream to stretch the carbonaceous filaments, thereby forming stretched carbonaceous filaments, and forming the stretched carbonaceous filaments into a sheet, the sheet forming at least a portion of the fuel cell gas diffusion layer.

In another aspect, the invention features a fuel cell gas diffusion layer that includes a substrate, and a sheet of melt blown carbonaceous filaments on the surface of the substrate.

In a further aspect, the invention features a membrane electrode assembly that includes two catalyst layers, a solid electrolyte and two gas diffusion layers. At least one of the gas diffusion layers includes a substrate and a sheet of melt blown carbonaceous filaments on the surface of the substrate.

In one aspect, the invention features a fuel cell that includes two flow plates and a membrane electrode assembly between the flow plates. The membrane electrode assembly that includes two catalyst layers, a solid electrolyte and two gas diffusion layers. At least one of the gas diffusion layers includes a substrate and a sheet of melt blown carbonaceous filaments on the surface of the substrate.

In another aspect, the invention features a fuel cell gas diffusion layer containing melt blown filaments.

Embodiments can include one or more of the following aspects.

Forming the sheet can include disposing the stretched carbonaceous filaments on a surface of a substrate.

The substrate can be at least about 0.02 millimeter thick and/or at most about 0.25 millimeter thick.

The gas diffusion layer can be formed of the substrate and the sheet.

The method gas diffusion layer can be at least about 0.05 millimeter thick and/or at most about 0.65 millimeter thick.

The substrate can be at least partially wound around a collector when the stretched filaments are disposed on the substrate.

The method can be a reel-to-reel type method.

The carbonaceous material can be pitch. The pitch can be mesophase pitch.

The method can further include heating the carbonaceous material before extruding the carbonaceous material. Heating the carbonaceous material can at least partially melts the carbonaceous material. The carbonaceous material can be heated to, for example, a temperature of at least about 250° C. and/or at most about 400° C.

The method can further include heating the gas stream before contacting the carbonaceous filaments with the gas stream. The temperature of the gas stream can be, for example, at least about 300° C. and/or at most about 400° C.

The method can further include impregnating the sheet with a binder (e.g., a carbonizable binder, such as a phenolic binder). The method can also include carbonizing and/or graphitizing the binder.

The stretched carbonaceous filaments can have an average diameter of at least about 0.5 micron and/or at most about 15 microns.

The stretched carbonaceous filaments can have an average length of at least about one millimeter and/or at least about 50 millimeters.

The fuel cell gas diffusion layer can have a flexural strength of at least about 300 psi.

The fuel cell gas diffusion layer can have a strength of at least about four pounds per inch.

The fuel cell gas diffusion layer can have an in-plane resistivity of at most about 50 mΩ-cm.

The fuel cell gas diffusion layer can have an through-plane resistivity of at most about 200 mΩ-cm.

The fuel cell gas diffusion layer can have a porosity of at least about 30%.

The sheet can be at least about 0.02 millimeter thick and/or at most about 0.5 millimeter thick.

The sheet can have a basis weight of at least about 10 grams per square meter and/or at most about 200 grams per square meter.

In certain embodiments, having melt blown filaments present in the gas diffusion layer can reduce the number of steps in the process of making the gas diffusion layer compared to certain methods of making a gas diffusion layer that does not contain melt blown filaments. For example, using melt blown filaments in the gas diffusion layer can allow the gas diffusion layer to be prepared without forming fibers, without cutting fibers, without dispersing fibers in water, and/or without forming paper. This can offer the advantage of reducing the cost and/or complexity of the process. It can also reduce the possibility of impurity introduction into the gas diffusion layer.

In some embodiments, the melt blown filaments contained in the gas diffusion layer can be formed by a process that allows for relatively straight forward manipulation of one or more dimensions of the filaments (e.g. average filament diameter, average filament length). As an example, by manipulating the velocity and/or temperature of the gas stream, one or more dimensions of the filaments can be manipulated.

In some embodiments, the gas diffusion layer can simultaneously exhibit desirable levels of flexibility, strength, in-plane resistivity, through-plane resistivity, porosity and chemical inertness.

Features, objects and advantages of the invention are in the description, drawings and claims.

### DESCRIPTION OF DRAWINGS

FIG. 1 is a cross-sectional view of an embodiment of a fuel cell;

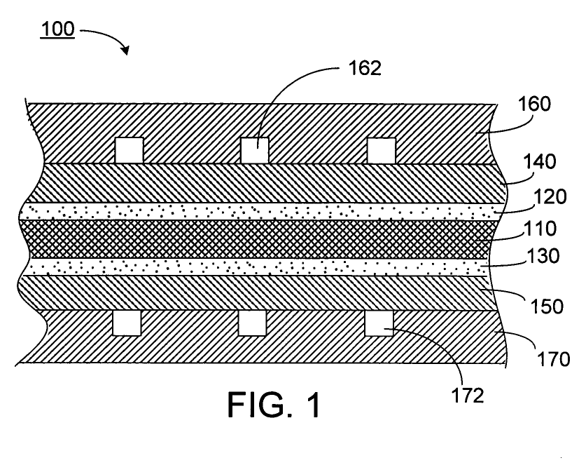

FIGS. 2A-2C are top, bottom and cross-sectional views, respectively, of an embodiment of a gas diffusion layer; and

FIG. 3 is an illustration of a system for forming melt blown filaments.

### DETAILED DESCRIPTION

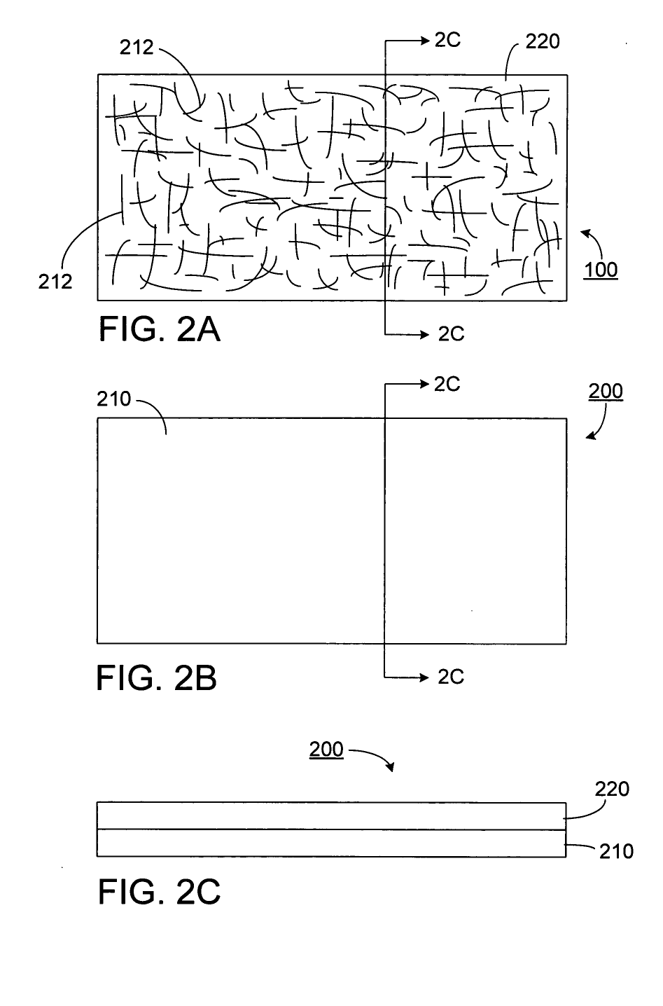

FIGS. 2A-2C show a gas diffusion layer 200 having a substrate 210 and a sheet 220 formed of melt blown mesophase pitch filaments 212.

As used herein, the term sheet refers to an article formed of a network of filaments. A sheet has a length to width ratio of at least about 10 (e.g., at least about 50, at least about 100).

As referred to herein, a melt blown filament refers to a filament of material formed by a melt blow process, such as the type described herein.

The filaments in a sheet have an average diameter of at least about 0.5 micron (e.g., at least about one micron, at least about two microns), an average diameter of at most about 15 microns (e.g., at most about 10 microns, at most about five microns), and an average length of at least about one millimeter (e.g., at least about 5 millimeters, at least about 10 millimeters). In some embodiments, a filament has a length of at least about 50 millimeters (e.g., at least about 100 millimeters, at least about 200 millimeters).

In certain embodiments, sheet 220 is at least about 0.02 millimeter (e.g., at least about 0.05 millimeter, at least about 0.1 millimeter) thick, and/or at most about 0.5 millimeter (e.g., at most about 0.2 millimeter) thick.

In some embodiments, sheet 220 has a basis weight of at least about 10 grams per square meter (gsm) (e.g., at least about 20 gsm, at least about 35 gsm) and/or at most about 200 gsm (e.g., at most about 100 gsm, at most about 50 gsm). As referred to herein, basis weight is determined according to TAPPI T-410/ASTM D-646.

Substrate 210 can be formed of a carbonaceous material, such as, for example, a wet laid carbon web in roll format or a dry laid carbon web in roll format. Substrate 210 can have a basis weight of, for example, from about 10 gsm to about 50 gsm (e.g., about 20 gsm).

In certain embodiments, substrate 210 is at least about 0.02 millimeter (e.g., at least about 0.05 millimeter) thick, and/or at most about 0.25 millimeter (e.g., at most about 0.15 millimeter) thick.

In some embodiments, gas diffusion layer 200 is at least about 0.05 millimeter (e.g., at least about 0.07 millimeter) thick, and/or at most about 0.65 millimeter (e.g., at most about 0.5 millimeter) thick.

In some embodiments, gas diffusion layer 200 can be relatively long and/or wide (e.g., such as can be prepared using an automated process). As an example, gas diffusion layer 200 can be at least about 15 centimeters (e.g., at least about 35 centimeters, at least about 50 centimeters) long.

In general, the length of gas diffusion layer 200 depends upon the apparatus used to form layer 200. Exemplary widths include from about 10 centimeters to about 50 centimeters (e.g., from about 10 centimeters to about 40 centimeters, from about 13 centimeters to about 30 centimeters).

In some embodiments, gas diffusion layer 200 has a flexural strength of at least about 300 psi (e.g., at least about 450 psi, at least about 600 psi). As referred to herein, the flexural strength of a gas diffusion layer is determined based on the compression modulus and caliper of the gas diffusion layer.

In certain embodiments, gas diffusion layer 200 has a strength of at least about four pounds per inch (e.g., at least about six pounds per inch, at least about 10 pounds per inch). As referred to herein, the strength of a gas diffusion layer is measured according to TAPPI T-494.

In certain embodiments, gas diffusion layer 200 has a through-plane resistivity of at most about 200 mΩ-cm (e.g., at most about 50 mΩ-cm, at most about 10 mΩ-cm, at most about five mΩ-cm). The through-plane resistivity of a gas diffusion layer, as referred to herein, is measured according to ASTM B 193-95.

In some embodiments, gas diffusion layer 200 has an in-plane resistivity of at most about 50 mΩ-cm (e.g., at most about 10 mΩ-cm, at most about five mΩ-cm). As referred to herein, the in-plane resistivity of a gas diffusion layer is measured according to ASTM B 193-95.

In certain embodiments, gas diffusion layer 200 has a porosity of at least about 30% (e.g., at least about 60%, at least about 80%). The porosity of a gas diffusion layer, as referred to herein, is measured based on the density and caliper of the gas diffusion layer.

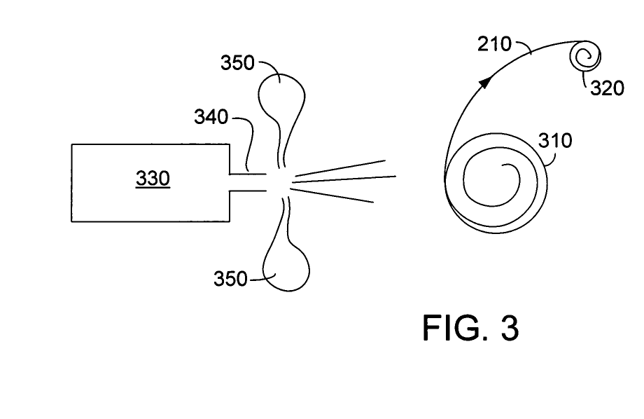

Referring to FIG. 3, in some embodiments, gas diffusion layer 200 is using a system 300 as follows. Substrate 210 is wound around reels 310 and 320 so that, as the reels rotate, substrate 210 moves in the direction indicated by the arrow. As reels 310 and 320 are rotating, the mesophase pitch (in pellet form) is introduced into a heated extruder 330, where the pitch is softened (e.g., melted) and forced through a die 340 in the form of filaments. The filaments are contacted by heated gas (e.g., air) stream formed by gas supply 350 that is in fluid communication with the material extruded from die 340. The gas stream stretches the filaments and forces them against the surface of substrate 210, where the stretched, melt blown mesophase pitch filaments form sheet 220.

In general, the pitch is heated to a temperature sufficient to extrude the pitch without substantially altering the chemical nature of the pitch (e.g., without substantially degrading the pitch). For example, the pitch can be heated in extruder 330 to a temperature of at least about 250° C. (e.g., at least about 275° C., at least about 300° C.) and at most about 400° C. (e.g., at most about 380° C., at most about 350° C.).

Generally, the gas temperature and velocity are selected to be sufficient to deform (e.g., stretch) the filaments to form the filaments into a dimension to form a sheet having the desired properties. In some embodiments, the gas stream is at least about 300° C. (e.g., at least about 320° C., at least about 340° C.) and at most about 400° C. (e.g., at most about 380° C. In general, the gas stream has a relatively high velocity.

In general, the gas is selected to be substantially chemically inert with the pitch filaments during the melt blow process. Examples of gases that can be used include air, nitrogen, argon, helium, krypton and neon. Mixtures of gases may also be used.

Melt blow apparatuses are commercially available from, for example, J & M Laboratories, Inc. (Dawsonville, Ga.).

The following example is illustrative only and not intended as limiting.

### EXAMPLE 1

A multi-layer structure including a sheet of melt blown synthesized mesophase filaments was prepared using a melt blow apparatus as follows.

The apparatus included a single screw extruder connected to a coat hanger die to feed the material into a single row of capillaries. The die had orifices with a 320 micrometer diameter with 35 orifices per inch for a total width of six inches. The gas stream was formed of air at a temperature of 370° C. The distance from the exit hole of the die to the collecting screen was about six inches. A light weight, wet laid carbon sheet (Hollingsworth & Vose 8000018, 10 grams per square meter) was used as the substrate.

Pellets of synthesized mesophase pitch (AR from Mitsubishi Gas) were extruded using the following zone temperature profile: Zone 1=450° F.; Zone 2=600° F.; Zone 3=620° F. The filaments were formed at a rate of about 0.2 gram/hole/minute, and the basis weight of the sheet formed of the melt blown filaments was about 10 grams per square centimeter.

While certain embodiments have been described, the invention is not limited to these embodiments.

As an example, in some embodiments, the sheet of melt blown filaments can be impregnated with a carbonizable binder. Examples of such binders include phenolic resin binders (e.g., Arofene 8121-Me-65 phenolic resin from Ashland Chemical). Impregnation can be achieved, for example, by spraying the melt blow sheet with the resin(s), saturating the melt blown sheet with the resin(s), screen printing the melt blown sheet with the resin(s) and/or using other coating techniques. Subsequent to impregnation, the binder can be carbonized and optionally graphitized. Conditions appropriate for carbonization and/or graphitization are known to those skilled in the art. This can enhance the electrical conductivity and/or chemical purity of the material.

As an example, in certain embodiments, the melt blow filaments are formed of materials other than mesophase pitch. Such materials include, for example, other forms of pitch and PAN.

As an example, in some embodiments, a gas diffusion layer includes one or more layers (e.g., one, two, three, four, five, six, seven, eight, nine, 10, etc.) between the substrate and the sheet of melt blow carbonaceous filaments. Such layers can be formed of, for example, SubL/MB or SubL/MB/SubL.

As another example, in certain embodiments, the gas diffusion layer can include a sheet of melt blown filaments (e.g., carbonaceous melt blow filaments) on the opposite surface of the substrate.

Other embodiments are in the claims.

1. A method of making a fuel cell gas diffusion layer, the method comprising:
extruding a carbonaceous material through openings in a die to form carbonaceous filaments;
contacting the carbonaceous filaments with a gas stream to stretch the carbonaceous filaments, thereby forming stretched carbonaceous filaments; and
forming the stretched carbonaceous filaments into a sheet, the sheet forming at least a portion of the fuel cell gas diffusion layer.

2. The method of claim 1, wherein forming the sheet includes disposing the stretched carbonaceous filaments on a surface of a substrate.

3. The method of claim 2, wherein the substrate is at least about 0.02 millimeter thick.

4. The method of claim 2, wherein the substrate is at most about 0.25 millimeter thick.

5. The method of claim 2, wherein the gas diffusion layer comprises the substrate and the sheet.

6. The method of claim 5, wherein the gas diffusion layer is at least about 0.05 millimeter thick.

7. The method of claim 5, wherein the gas diffusion layer is at most about 0.65 millimeter thick.

8. The method of claim 2, wherein the substrate is at least partially wound around a collector when the stretched filaments are disposed on the substrate.

9. The method of claim 8, wherein the method is a reel-to-reel type method.

10. The method of claim 1, wherein the carbonaceous material comprises pitch.

11. The method of claim 10, wherein the pitch comprises mesophase pitch.

12. The method of claim 1, further comprising heating the carbonaceous material before extruding the carbonaceous material.

13. The method of claim 12, wherein heating the carbonaceous material at least partially melts the carbonaceous material.

14. The method of claim 12, wherein the carbonaceous material is heated to a temperature of at least about 250° C.

15. The method of claim 12, wherein the carbonaceous material is heated to a temperature of at most about 400° C.

16. The method of claim 1, further comprising heating the gas stream before contacting the carbonaceous filaments with the gas stream.

17. The method of claim 16, wherein a temperature of the gas stream is at least about 300° C.

18. The method of claim 16, wherein a temperature of the gas stream is at most about 400° C.

19. The method of claim 1, wherein the stretched carbonaceous filaments have an average diameter of at least about 0.5 micron.

20. The method of claim 1, wherein the stretched carbonaceous filaments have an average diameter of at most about 15 microns.

21. The method of claim 1, wherein the stretched carbonaceous filaments have an average length of at least about one millimeter.

22. The method of claim 1, wherein the stretched carbonaceous filaments have an average length of at least about 50 millimeters.

23. The method of claim 1, wherein the fuel cell gas diffusion layer has a flexural strength of at least about 300 psi.

24. The method of claim 1, wherein the fuel cell gas diffusion layer has a strength of at least about four pounds per inch.

25. The method of claim 1, wherein the fuel cell gas diffusion layer has an in-plane resistivity of at most about 50 mΩ-cm.

26. The method of claim 1, wherein the fuel cell gas diffusion layer has an through-plane resistivity of at most about 200 mΩ-cm.

27. The method of claim 1, wherein the fuel cell gas diffusion layer has a porosity of at least about 30%.

28. The method of claim 1, wherein the sheet is at least about 0.02 millimeter thick.

29. The method of claim 1, wherein the sheet is at most about 0.5 millimeter thick.

30. The method of claim 1, wherein the sheet has a basis weight of at least about 10 grams per square meter.

31. The method of claim 1, wherein the sheet has a basis weight of at most about 200 grams per square meter.

32. The method of claim 1, further comprising impregnating the sheet with a binder.

33. The method of claim 32, wherein the binder comprises a carbonizable binder.

34. The method of claim 32, further comprising carbonizing the binder.

35. The method of claim 34, further comprising graphitizing the binder.

36. A fuel cell gas diffusion layer, comprising:
a substrate having a surface; and
a sheet of melt blown carbonaceous filaments on the surface of the substrate.

37. The fuel cell gas diffusion layer of claim 36, wherein the sheet is at least about 0.02 millimeter thick.

38. The fuel cell gas diffusion layer of claim 36, wherein the sheet is at most about 0.5 millimeter thick.

39. The fuel cell gas diffusion layer of claim 36, wherein the sheet has a basis weight of at least about 10 grams per square meter.

40. The fuel cell gas diffusion layer of claim 36, wherein the sheet has a basis weight of at most about 200 grams per square meter.

41. The fuel cell gas diffusion layer of claim 36, wherein the substrate is at least about 0.02 millimeter thick.

42. The fuel cell gas diffusion layer of claim 36, wherein the substrate is at most about 0.25 millimeter thick.

43. The fuel cell gas diffusion layer of claim 36, wherein the gas diffusion layer is at least about 0.05 millimeter thick.

44. The fuel cell gas diffusion layer of claim 36, wherein the gas diffusion layer is at most about 0.65 millimeter thick.

45. The fuel cell gas diffusion layer of claim 36, wherein the carbonaceous filaments comprise pitch.

46. The fuel cell gas diffusion layer of claim 45, wherein the pitch comprises mesophase pitch.

47. The fuel cell gas diffusion layer of claim 36, wherein the carbonaceous filaments have an average diameter of at least about 0.5 micron.

48. The fuel cell gas diffusion layer of claim 36, wherein the carbonaceous filaments have an average diameter of at most about 15 microns.

49. The fuel cell gas diffusion layer of claim 36, wherein the carbonaceous filaments have an average length of at least about one millimeter.

50. The fuel cell gas diffusion layer of claim 36, wherein the carbonaceous filaments have an average length of at least about 50 millimeters.

51. The fuel cell gas diffusion layer of claim 36, wherein the fuel cell gas diffusion layer has a flexural strength of at least about 300 psi.

52. The fuel cell gas diffusion layer of claim 36, wherein the fuel cell gas diffusion layer has a strength of at least about four pounds per inch.

53. The fuel cell gas diffusion layer of claim 36, wherein the fuel cell gas diffusion layer has an in-plane resistivity of at most about 50 mΩ-cm.

54. The fuel cell gas diffusion layer of claim 36, wherein the fuel cell gas diffusion layer has an through-plane resistivity of at most about 200 mΩ-cm.

55. The fuel cell gas diffusion layer of claim 36, wherein the fuel cell gas diffusion layer has a porosity of at least about 30%.

56. The fuel cell gas diffusion layer of claim 36, wherein the substrate has a second surface opposite the surface on which the carbonaceous filaments are disposed, the second surface being substantially devoid of melt blown carbonaceous filaments.

57. A membrane electrode assembly, comprising:
a first catalyst layer;
a second catalyst layer;
a solid electrolyte;
a first gas diffusion layer, the first gas diffusion layer comprising:
a first substrate having a surface; and
a first sheet of melt blown carbonaceous filaments on the surface of the first substrate; and
a second gas diffusion layer.

58. The membrane electrode assembly of claim 57, wherein the second gas diffusion layer comprises:
a second substrate having a surface; and
a second sheet of melt blown carbonaceous filaments on the surface of the second substrate.

59. A fuel cell, comprising:
a first flow plate;
a second flow plate; and
the membrane electrode assembly according to claim 59, the membrane electrode assembly being between the first and second flow plates.

60. The fuel cell of claim 59, wherein the second gas diffusion layer comprises:
a second substrate having a surface; and
a second sheet of melt blown carbonaceous filaments on the surface of the second substrate.

61. A fuel cell gas diffusion layer containing melt blown filaments.

62. The fuel cell gas diffusion layer of claim 61, wherein the melt blown filaments comprise a carbonaceous material.

63. The fuel cell gas diffusion layer of claim 62, wherein the carbonaceous material comprises pitch.

64. The fuel cell gas diffusion layer of claim 63, wherein the pitch comprises mesophase pitch.
